(19) United States
(12) Patent Application Publication
(10) Pub. No.: US 2020/0035028 A1
(43) Pub. Date: Jan. 30, 2020

(54) AUGMENTED REALITY (AR) DOPPLER WEATHER RADAR (DWR) VISUALIZATION APPLICATION

(71) Applicant: Raytheon Company, Waltham, MA (US)

(72) Inventors: Mark A. Cornell, Omaha, NE (US); Nicole A. Haffke, La Vista, NE (US); Sabien D. Jarmin, Omaha, NE (US); Rachel M. Phinney, Lincoln, NE (US)

(21) Appl. No.: 16/372,666

(22) Filed: Apr. 2, 2019

Related U.S. Application Data
(60) Provisional application No. 62/711,910, filed on Jul. 30, 2018.

(51) Int. Cl. G06T 19/00; G01S 13/95; G01S 7/04; G01W 1/06; G06T 13/60

(52) U.S. Cl. CPC G06T 19/006; G01S 13/955; G01W 2203/00; G01W 1/06; G06T 13/60; G01S 7/04

(57) ABSTRACT

Disclosed in some examples are methods, systems, devices, and machine-readable mediums for augmented reality (AR) Doppler weather radar (DWR) visualization application. A method is disclosed that includes retrieving weather radar data from a weather radar. The method may further include generating two (2) dimensional (D) polygons from the weather radar data, wherein the weather data comprises a three (3) D coordinate and a value indicating a weather condition, and wherein the 2D polygons are generated based on values of the value indicating the weather condition and an area of coverage. The method may further include sending the 2D polygons to an augmented-reality (AR) weather radar visualization system for the AR weather radar system to present a 3D rendering of the 2D polygons. The method may provide real-time weather 3D radar data that is animated.

### CROSS-REFERENCE TO RELATED APPLICATION

This patent application claims the benefit of U.S. Provisional Patent Application No. 62/711,910, filed. Jul. 30, 2018, entitled “AUGMENTED REALITY (AR) DOPPLER WEATHER RADAR (DWR) VISUALIZATION APPLICATION”, which is incorporated by reference herein in its entirety.

### TECHNICAL FIELD

Some embodiments relate to the presentation of three (3) dimensional (3D) weather with animation (4D) using augmented reality (AR) Doppler weather radar data (DWR). Some embodiments relate to the generation of 2D polygons and weather alerts from weather radar data in real time.

### BACKGROUND

People responsible for weather prediction and monitoring may have a difficult time interpreting the weather data due to the large volume of weather data. Additionally, the volume of the weather data continues to increase. People responsible for weather prediction and monitoring may have a difficult time determining whether there is a weather alert due to the large amount of weather data.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a system for AR-DWR visualization in accordance with some embodiments:

FIG. 2 illustrates a system or AR-DWR visualization in accordance with some embodiments;

FIG. 3 illustrates a 4D AR-DWR visualization in accordance with some embodiments;

FIG. 4 illustrates a system for AR-DWR visualization in accordance with some embodiments;

FIG. 5 illustrates a system for AR-DWR visualization in accordance with some embodiments;

FIG. 6 illustrates a system for AR-DWR visualization in accordance with some embodiments;

FIG. 7 illustrates a method for AR-DWR visualization in accordance with some embodiments; and

FIG. 8 illustrates a block diagram of an example machine upon which any one or more of the techniques (e.g., methodologies) discussed herein may perform.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

In some embodiments, the 3D or 4D (animation) AR-DWR visualization will enable users of the system to more easily analyze the weather situation. In some embodiments, the 3D or 4D (animation) AR-DWR visualization enables a user to interpret radar data quicker. In some embodiments, the 3D or 4D (animation) AR-DWR visualization enables a user to more quickly identify dangerous weather conditions and determine possible actions. In some embodiments, the 3D or 4D (animation) AR-DWR visualization enables a user to view weather data in 3D rather than 2D.

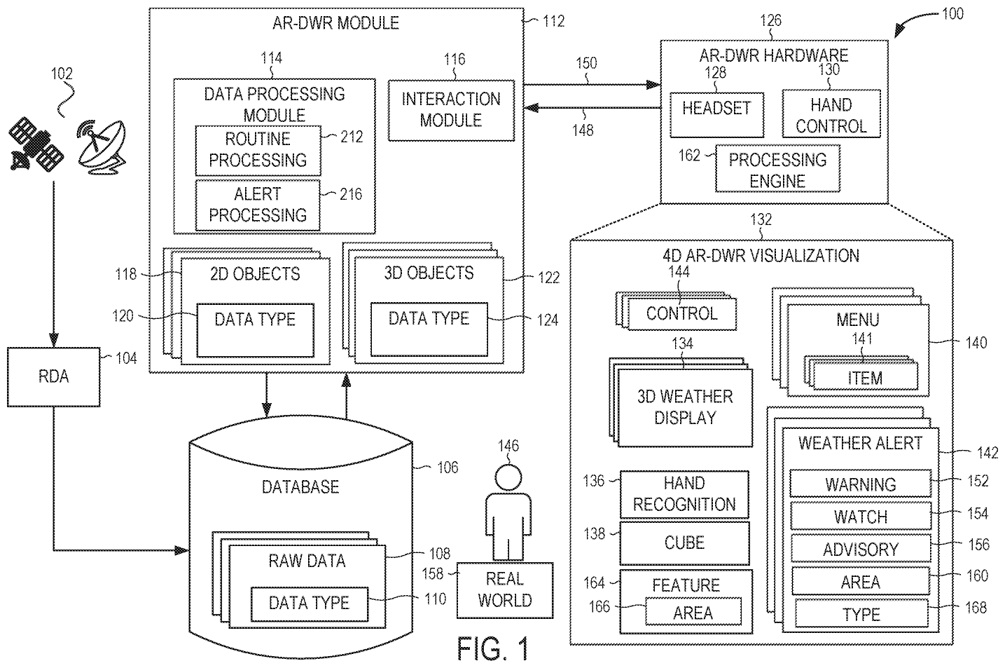

FIG. 1 illustrates a system for AR-DWR visualization 100 in accordance with some embodiments. Illustrated in FIG. 1 is radars 102, radar data acquisition (RDA) 104, database 106, AR-DWR 112, 3D AR-DWR hardware 126, 4D AR-DWR visualization 132, a user 146, and the real world 158. The RDA 104 processes the data from the radars 102 and stores them in the database 106 as raw data 108. The raw data 108 is processed by the data processing module 114 to generate 2D objects 118 and 3D objects 122. The interaction module 116 interacts with the 3D AR-DWR hardware 126 to present 4D AR-DWR visualization 132 (3D rendering and 4D animation) for the user 146, which may be in real-time (e.g., there may be at most a 30-40 second delay between when the 4D AR-DWR visualization 132 is presented and when the raw data 108 was collected).

In some embodiments, the system for AR-DWR visualization 100 complies with Federal Aviation Administration (FAA) standards or regulations, and/or National Oceanic and Atmospheric Administration (NOAA) standards or regulations. The real world 158 may be what the user 146 is looking (e.g., a map or room) where the augmented reality of the 4D) AR-DWR visualization 132 may add the graphics to. The system for AR-DWR visualization 100 may utilize an application program interface (API) of an Advanced Weather Interactive Processing System (AWIPS®)/JET® application.

The radars 102 may be Spectrum Efficient National Surveillance Radar (SENSR), Doppler weather radar, legacy next generation radar (NEXRAD), Terminal Doppler Weather Radar (TDWR), Raytheon® Skyterm™, X-Band Low Power Radar (LPR), satellites, ground-based radar, X-band radar (e.g., 30 seconds to do a full volume), or another type of radar.

The RDA 104 may be a module or application that processes the data from the radars 102 and stores the raw data 108 in a database 106. The RDA 104 may be hosted by a computer, which may be on a same computer as AR-DWR module 112 and database 106 or a different computer. The RDA 104 may reside over a computer network from the database 106 and/or AR-DWR module 112.

The database 106 may be electronic storage for the raw data 108. The database 106 may reside over a computer network from the RDA 104 and/or AR-DWR module 112. The raw data 108 may be data from the radars 102. The raw data 108 may have one or more data types 110. The data types 110 may be reflectivity (e.g., composite reflectivity), wind velocity (e.g., storm relative velocity, radial velocity), temperature, etc. In some embodiments the database 106 may store the raw data 108 in a geographical hash storage system that enables quicker access to the raw data 108.

The AR-DWR module 112 may include data processing module 114, interaction module 116, 2D objects 118, and 3D objects 122. The AR-DWR module 112 may be part of Advanced Weather Interactive Processing System (AWIPS®) and/or uFrame™. The data processing module 114 may include routine processing 212 and alert processing 216, one or more of which may be across a computer network. The data processing module 114 may be an AWIPS II® application that takes the raw data 108 and generates the 2D objects 118 and the 3D objects 122. The data processing module 114 and/or interaction module 116 may determine the weather alerts 142 from the raw data 108, 2D objects 118, and/or 3D objects 122. For example, data processing module 114 and/or interaction module 116 may determine that there is a hail core (e.g., a warning 152) based on reflectivity of 2D objects 118, 3D objects 122, and/or raw data 108. The data processing module 114 and/or interaction module 116 may determine an area 160 for the weather alert 142. The data processing module 114, interaction module 116, and/or processing engine 162 may determine colors for the weather alerts 142.

Table 1 illustrates some types of raw data 108 available through AWIPS. The raw data may include an AWIPS header (not illustrated in Table 1), which may be the data type 110 in conjunction with the product code. The description indicates the type of the data type 110. The range indicates the range of the raw data 108.

TABLE 1
Types of Raw Data

| PRODUCT CODE | Description | Range |
|---|---|---|
| 94 | Spectrum Width | 124 nm |
| 99 | Reflectivity | 124 nm |
| 101 | Radial Velocity | 124 nm |

Table 2 illustrates additional types of raw data 108. Table 2 may illustrate products available for X-band. The range is smaller and thus there may be more data per a volume of weather. The raw data may include an AWIPS header (not illustrated in Table 1), which may be the data type 110 in conjunction with the product code.

TABLE 2
Types of Raw Data

| PRODUCT CODE | Description | Range |
|---|---|---|
| 1000 | AHV Velocity | 18 nm |
| 1001 | Reflectivity | 18 nm |
| 1003 | Radial Velocity | 18 nm |
| 1005 | Spectrum Width | 18 nm |

Table 3 illustrates additional types of raw data 108. Table 3 may illustrate products available for NEXRAD Level 2 Products. The header for all the rows may indicate NEXRAD Level 2 Products. The data type 110 is NEXRAD Level 2 Products in conjunction with the product code.

TABLE 3
Types of Raw Data

| PRODUCT CODE | Description | Range |
|---|---|---|
| 19 | Base Reflectivity (lowest elv angle) | 124 nm |
| 19 | Base Reflectivity (second lowest) | 124 nm |
| 19 | Base Reflectivity (third lowest) | 124 nm |
| 19 | Base Reflectivity (fourth lowest) | 124 nm |
| 27 | Base Velocity (lowest elev angle) | 124 nm |
| 27 | Base Velocity (second lowest) | 124 nm |
| 27 | Base Velocity (third lowest) | 124 nm |
| 27 | Base Velocity (fourth lowest) | 124 nm |
| 56 | Storm Relative Velocity (Lowest elev | 124 nm |
| | angle) | |
| 56 | Storm Relative Velocity (second lowest) | 124 nm |
| 56 | Storm Relative Velocity (third lowest) | 124 nm |
| 56 | Storm Relative Velocity (Fourth lowest) | 124 nm |
| 57 | Vertical Integrated Liquid | 124 nm |
| 159 | Differential Reflectivity (.5 deg elev) | 162 nm |
| 159 | Differential Reflectivity (.9 deg elev) | 162 nm |
| 159 | Differential Reflectivity (1.5 deg elev) | 162 nm |
| 159 | Differential Reflectivity (1.8 deg elev) | 162 nm |
| 159 | Differential Reflectivity (2.4 deg elev) | 162 nm |
| 159 | Differential Reflectivity (3.4 deg elev) | 162 nm |
| 161 | Correlation Coefficient (.5 deg) | 162 nm |
| 161 | Correlation Coefficient (.9 deg) | 162 nm |
| 161 | Correlation Coefficient (1.5 deg) | 162 nm |
| 161 | Correlation Coefficient (1.8 deg) | 162 nm |
| 161 | Correlation Coefficient (2.4 deg) | 162 nm |
| 161 | Correlation Coefficient (3.4 deg) | 162 nm |
| 163 | Specific Differential Phase (.5 deg) | 162 nm |
| 163 | Specific Differential Phase (.9 deg) | 162 nm |
| 163 | Specific Differential Phase (1.5 deg) | 162 nm |
| 163 | Specific Differential Phase (1.8 deg) | 162 nm |
| 163 | Specific Differential Phase (2.4 deg) | 162 nm |
| 163 | Specific Differential Phase (3.4 deg) | 162 nm |
| 165 | Hydrometeor Classification (.5 deg) | 162 nm |
| 165 | Hydrometeor Classification (.9 deg) | 162 nm |
| 165 | Hydrometeor Classification (1.5 deg) | 162 nm |
| 165 | Hydrometeor Classification (1.8 deg) | 162 nm |
| 165 | Hydrometeor Classification (2.4 deg) | 162 nm |
| 165 | Hydrometeor Classification (3.4 deg) | 162 nm |
| 166 | Melting Layer (.5 deg elev) | 162 nm |
| 166 | Melting Layer (.9 deg elev) | 162 nm |
| 166 | Melting Layer (1.5 deg elev) | 162 nm |
| 166 | Melting Layer (1.8 deg elev) | 162 nm |
| 166 | Melting Layer (2.4 deg elev) | 162 nm |
| 166 | Melting Layer (3.4 deg elev) | 162 nm |

The 2D objects 118 may include data type 120. The data type 120 may be reflectivity, wind velocity, temperature, etc. The 3D objects 122 may include data type 124. The data type 124 may be reflectivity, wind velocity, temperature, etc. The data type 120, 124 may be termed metadata because it is derived from the raw data 108. The 3D objects 122 may be faces of objects that are rendered to present the 4D AR-DWR visualization 132. Without the construction of faces for the 3D objects 122 then the raw data 108 is information about individual points, e.g., x, y, z, coordinate with the information that is data for that point such as wind velocity, reflectivity, temperature, etc. The routine processing 212 may perform routine processing for 3D weather display 134. The alert processing 216 may determine weather alerts 142. For example, the alert processing 216 may be configured to examine the raw data 108 and determine whether a weather alert 142 is indicated by the raw data 108. The alert processing 216 may use artificial intelligence or other means to perform alert processing 216. In some embodiments, people examine the raw data 108 and generate weather alerts 142. In some embodiments, the user 146 may indicate that a portion of the 3D weather display 134 should be part of a weather alert 142, which generates a new weather alert 142.

In some embodiments, the AR-DWR module 112 may include or be in communication with Microsoft HoloLens®. In some embodiments, AR-DWR module 112 may make calls to application program interfaces (APIs) of an AR application, e.g., Microsoft HoloLens®. In some embodiments, AR-DWR module 112 may be or include Raytheon® Airline Aviation Services (RAAS). In some embodiments, AR-DWR module 112 may be or include SPARK. In some embodiments, AR-DWR module 112 may be a RAAS 557th radar product generator (RPG) AF weather forecaster (WF). In some embodiments, AR-DWR module 112 may be a RPG.

The interaction module 116 may respond to interactions 148 from the user 146 and/or 3D AR-DWR hardware 126 with responses 148. The interactions 148 may be an indication of a hand recognition 136, a cube 138, a selection of an item 141 of the menu 140, an operation of a control 144, etc. The responses 148 may be 2D objects 118, 3D objects 124, menus 140, weather alerts 142, raw data 108, etc. The interaction module 116 may control the 3D AR-DWR hardware 126. In some embodiments, the 3D AR-DWR hardware 126 may control the generation of the 4D AR-DWR visualization 132 by making calls (e.g., interactions 148) to the AR-DWR module 112. An example interaction 148 may be a selection of an area of the 4D AR-DWR visualization 132 for greater detail with the response 148 being greater detail in the 2D objects 118 and/or 3D objects 124 so that great detail may be displayed for an area of the 4D AR-DWR visualization 132. In some embodiments the 2D objects 118 and/or the 3D objects 122 may be stored in a geographical hash storage system that enables quicker access that may enable the 4D AR-DWR visualization 132 to be updated in real time. In some embodiments, the weather alerts 142, 2D objects 118 and/or the 3D objects 122 are stored with a geographical hash to enable quicker retrieval.

The AR-DWR hardware 126 may include a headset 128, a hand control 130, processing engine 162, and other AR-DWR hardware. The 3D AR-DWR hardware 126 may include other connections to other software/hardware. For example, the 3D AR-DWR hardware 126 may include Microsoft HoloLens 2® and/or SPARK. In some embodiments, the 3D AR-DWR hardware 126 may include additional or different hardware. The AR-DWR hardware 126 may include a wireless connection to AR-DWR, module 112. The AR-DWR hardware 126 may be a standalone headset, with the standalone headset including the AR-DWR module 112, in accordance with some embodiments. The processing engine 162 may render the 4D AR-DWR visualization 132. The processing engine 162 may communicate with the AR-DWR module 112. The processing engine 162 may recognize the hand recognition 136, selection of cube 138, the controls 144, an item 141 of a menu 140, etc. The processing engine 162 may determine coordinates to use to display the AR on the real world 158.

The 4D AR-DWR visualization 132 may include one or more of 3D weather display 134, hand recognition 136, cube 138, menus 140, weather alert , controls 144, feature 164. The 4D AR-DWR visualization 132 may be mixed reality visualization of 3D objects 122. The weather alert 142 may include watches 152, warnings 154, advisories 156, area 160, and type 168. The area 160 may be an area of a warning 152, watch 154, and/or advisory 156. The type 168 may be for strong winds, shearing winds, tornado, hail, etc. The controls 144 may be controls for the user 146 to select, e.g., a zoom control, a control to select a feature 164, a control to select color palette, etc.

Table 4 illustrates an embodiment of weather alerts 142. Where each type 168 includes a name and a priority. An active bookmark (NN) may be of type 168 user defined. A user defined type 168 may be where a user 146 has defined a type of weather alert 142 with the system for AR-DWR visualization 100. The user 146 may select an area of the 3D weather display 134 and define the weather alert 142.

TABLE 4
Weather Alerts

| Type | Name | Priority |
|---|---|---|
| TVS | Tornadic Vorticity Signature | 1 |
| User Defined | Active Bookmark (NN) | 2 |
| Meso | Mesocyclone | 3 |
| Hail | Hail (>=.75″ diameter) | 4 |
| WWA | Watch/Warning/Advisory | 5 |

The hand recognition 136 may be selection of a menu item 141, a selection of an object (e.g., 3D objects 122, cube 138, control 144, weather alert 142, etc.). The selection of an object may be based on a hand gestor, an articulated hand gestor, eye tracking, etc. In some embodiments, the 4D AR-DWR visualization 132 may be transmitted across a network to other users 146, e.g., a user 146 may view the 4D AR-DWR visualization 132 on a mobile smartphone. In some embodiments, users 146 may share the 4D AR-DWR visualization 132 with a same set of coordinates, so that the 3D rendering of the 3D objects 122 is based on the same coordinate system. The feature 164 may include an area 166. The feature 164 may be an area of the 4D AR-DWR visualization 132 selected by the user 146. The features 164 may be stored using a geographical hash to enable quicker retrieval. In some embodiments, the feature 164 may be selected and changed into a weather alert 142, which may be shared over a network to other users 146 and/or other 4D AR-DWR visualizations 132.

The user 146 may be one or more people (e.g., forecaster, weather presenter, home user, etc.) that are using the AR-DWR hardware 126 to view the 4D AR-DWR visualization 132. The functionality described in connection with FIG. 1 may be organized differently. For example, functionality described in conjunction with RDA 104, AR-DWR module 112, and processing engine 162 may be distributed differently.

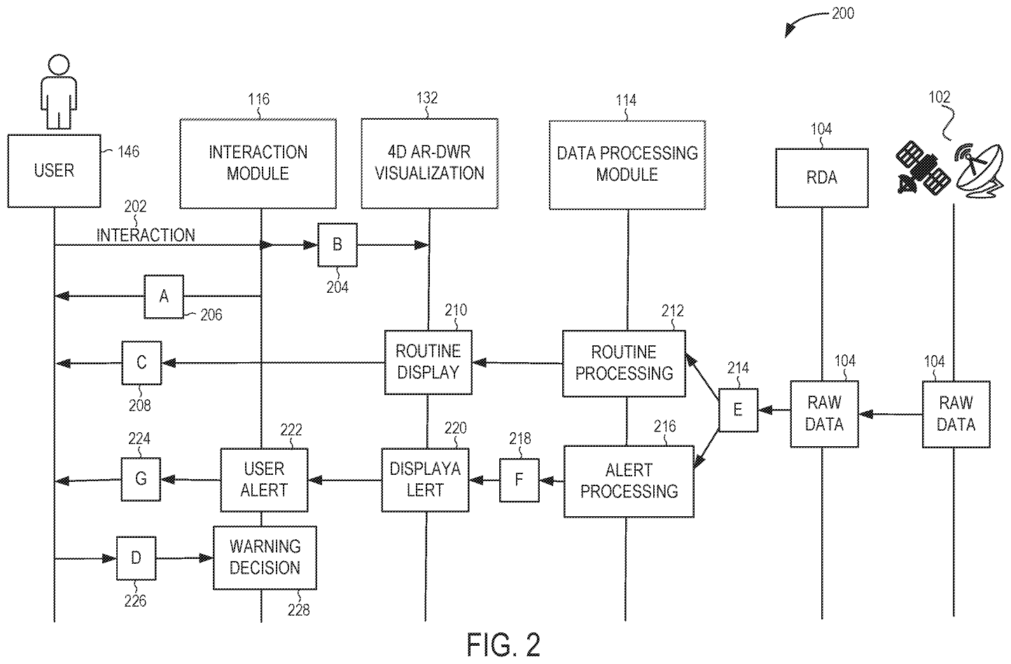

FIG. 2 illustrates a system for AR-DWR visualization 200 in accordance with some embodiments. Illustrated in FIG. 2 is user 146, interaction module 116, 4D AR-DWR visualization 132, data processing module 114, RDA 104, and radars 102. User 146 may be the same or similar as user 146 as disclosed in conjunction with FIG. 1. Interaction module 116 may be the same or similar as interaction module 116 as disclosed in conjunction with FIG. 1. 4D AR-DWR visualization 132 may be the same or similar as 4D AR-DWR visualization 132 as disclosed in conjunction with FIG. 1. Data processing model 114 may be the same or similar as disclosed in conjunction with FIG. 1. RDA 104 may be the same or similar as disclosed in conjunction with FIG. 1.

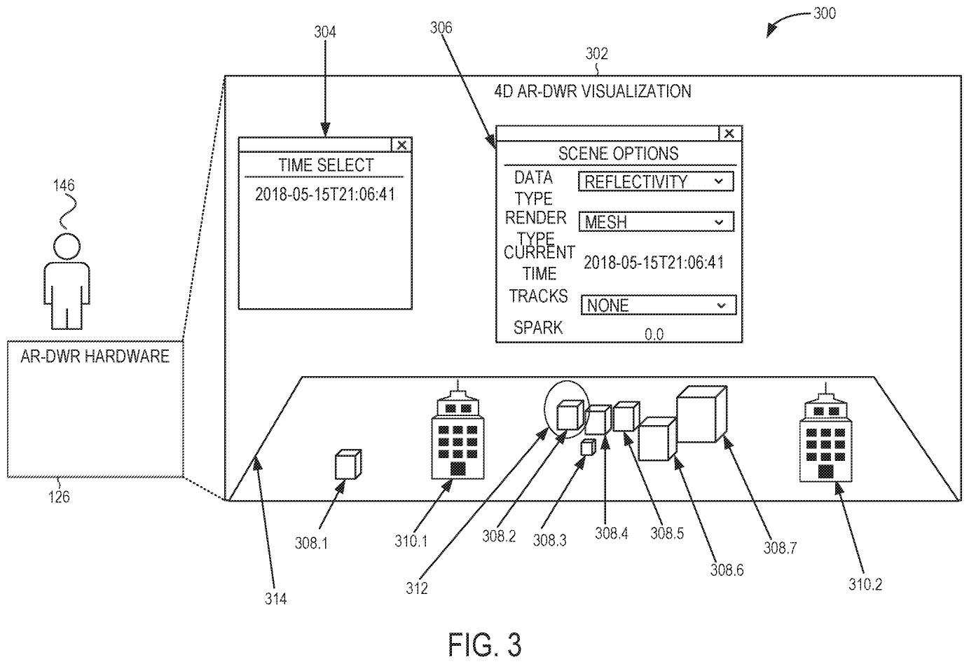

FIGS. 2 and 3 will be disclosed in conjunction with one another. FIG. 3 illustrates a 4D AR-DWR visualization 300 in accordance with some embodiments illustrated in FIG. 3 is user 146, AR-DWR hardware 126, 4D AR-DWR visualization 302, time select 304, scene options 306, weather 308, real-world objects 310, weather alert 312, map 314. User 146 may be the same or similar as user 146 as disclosed in conjunction with FIG. 1. AR-DWR hardware 126 may be the same or similar as AR-DWR hardware 126 as disclosed in conjunction with FIG. 1. 4D AR-DWR visualization 302 may be the same or similar as 4D AR-DWR visualization 132 as disclosed in conjunction with FIG. 1. Time select 304 may be a control 144, menu 140, or another interface device. Scene options 306 may be a control 144, menu 140, or another interface device. Weather 308 may be the same or similar as 3D weather display 134, which may be a rendering of 3D objects 122, Real-world objects 310 and map 314 may be objects that are real that the 4D AR-DWR visualization 300 are rendered around. Example real-world objects 300 include maps, rooms, tables, etc. Weather alert 312 may be a weather alert 142, e.g., warning 152, watch 154, or advisory 156.

Returning to FIG. 2, interaction 202 may be a flow of interactions (e.g., selection of a different data type such as wind velocity rather than reflectivity in the scene options 306 menu) from user 146 to the interaction module 116.

The interaction module 116 may respond to an interaction 202 with B 204, which may be a flow of requests to update the 4D AR-DWR visualization 132, e.g., to update the 3D weather display 134 with a different data type such as wind velocity. The interaction module 116 may generate or retrieve 3D objects 122 with a data type of wind velocity. The interaction module 116 may then send B 204 to the AR-DWR hardware 126 to update the 3D weather display 134 with the 3D objects 122 with data type 124 of wind velocity.

A 206 indicates a flow of data that are responses to interactions 202. A 206 may be from the interaction module 116 to the user 146. For example, it may be a confirmation of the interaction 202. The responses may be indicted by the 4D AR-DWR visualization 132 to the user 146.

C 208 may be a flow of data from the 4D AR-DWR visualization 132, which may be updated frequently. The routine display 210 indicates routine 3D weather display 134, e.g., weather 308. A data flow may be from the radars 102 to the routine display 210. For example, raw data 104 may come from the radars 102 and be processed by the RDA 104. E 214 represents the raw data 104 being distributed to data processing module 114. The raw data 104 may be distributed to many different data processing modules 114 via various computer networks. The data processing module 114 may perform routine processing 212, e.g., 3D weather display 134 such as weather 308, and perform alert processing 216, e.g., weather alert 142 such as weather alert 312. The alert processing 216 is a data flow F 218 of alerts that represent high-threat alerts that prompt the forecaster to determine the best course of action to protect life and property. The data processing module 114 may be configured to insure that data flow F 218 is presented immediately on the 4D AR-DWR visualization 132. Data flow F 218 may be transmitted on a computer network with a higher service level than data flow E 214. The alert processing 216 may include artificial intelligence and other techniques to determine weather alerts 142 from the raw data 104, e.g., a tornado decision algorithm may be included in the alert processing 216.

Data flow F 218 may denote that continue with display alert 220 where the 4D AR-DWR visualization 132 includes the alert. For example, data processing module 114 may have send a response 150 to AR-DWR hardware 126 indicating that a weather alert 142 had a high priority for display.

Data flow G 224 indicates a user alert 222 from a weather alert 142 that is a high-threat alert. The high-threat alert may invoke data flow D 226. Data flow D 226 may be a data flow where the user 146 makes a decision regarding a high-threat alert. Warning decision 228 may indicate that the user 146 is presented with a decision to issue a weather alert 142 as a warning 152 for the displayed alert 220. In some embodiments user alert 222 may be generated based on the user 146 indicating a portion of the 3D weather display 134 is a weather alert 142.

In some embodiments the processing may be distributed. For example, RDA 104 may be on a server across a network, data processing module 114 may be on another server across a network, and alert processing 216 may be on another server across a network.

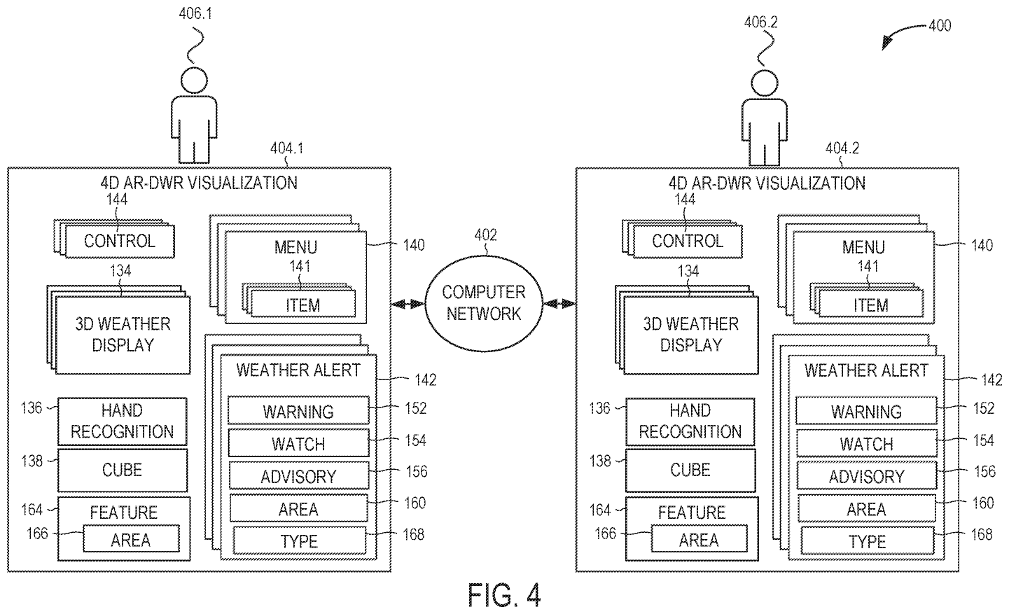

FIG. 4 illustrates a system for AR-DWR visualization 400 in accordance with some embodiments. Illustrated in FIG. 4 are users 406.1, 406.2 and 4D AR-DWR visualization 404.1, 404.2. Users 406.1, 406.2 may be the same or similar as user 146 of FIG. 1. 4D AR-DWR, visualization 404.1, 404.2 may be the same or similar as 4D AR-DWR visualization 132. The computer network 402 may be the internet or another combination of local area networks and the internet. In some embodiments, the computer network 402 may be a private network. User 406.1 and user 406.2 may share a same 4D DWR visualization 404.1, 404.2 with a same set of coordinates. Weather alerts 142 created by one user 406.1, 406.2 may be transmitted over the computer network 402 and shared with one or more additional users.

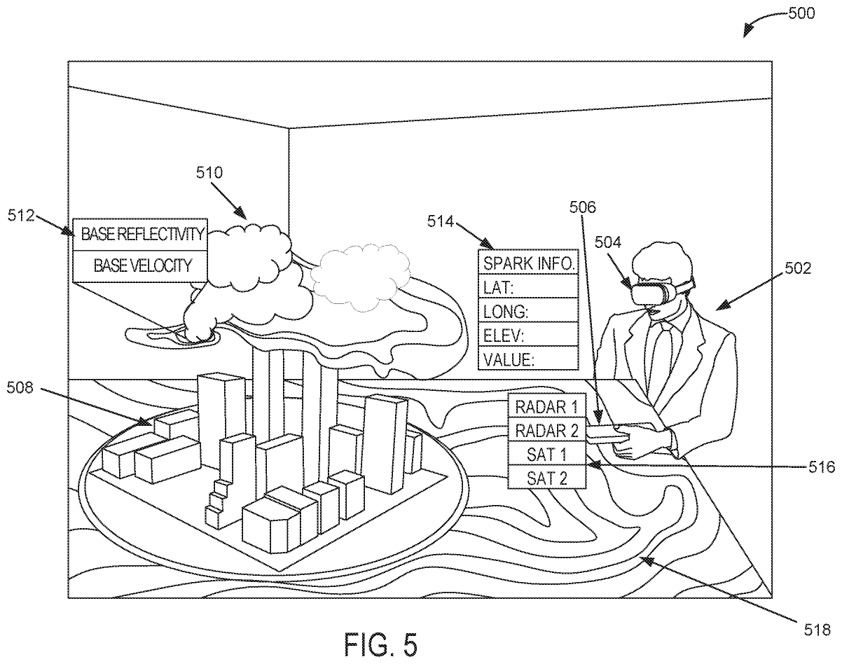

FIG. 5 illustrates a system for AR-DWR visualization 500 in accordance with some embodiments. Illustrated in FIG. 5 is user 502, headset 504, hand control 506, 3D weather display 508, 510, weather label 512, position information 514, menu 516, table top 518. The user 502 is seeing an AR-DWR visualization using the headset 504 and selecting items of a menu 516 using a hand control 506. The user 502 may be the same or similar as user 146. The headset 504 may be the same or similar as headset 128. The hand control 506 may be the same or similar as hand control 130. The 3D weather display 508, 510 may be the same or similar as 3D weather display 134. The 3D weather display 508, 510 may include a map portion 508 and a weather portion 510. The weather label 512 may provide information regarding the 3D weather display 508, 510, e.g., that the 3D weather display regarding base velocity and base reflectivity, which may be color coded. Position information 514 may indicate position information for the 3D weather display 508, 510. The menu 516 may be the same or similar as menu 140. The menu 516 may provide options for the 3D weather display 508, 510, and as illustrated may be selected using the hand control 506. The table top 518 may be the same or similar as the real world 158. The AR-DWR visualization may be 4D in that it may be animated in real-time.

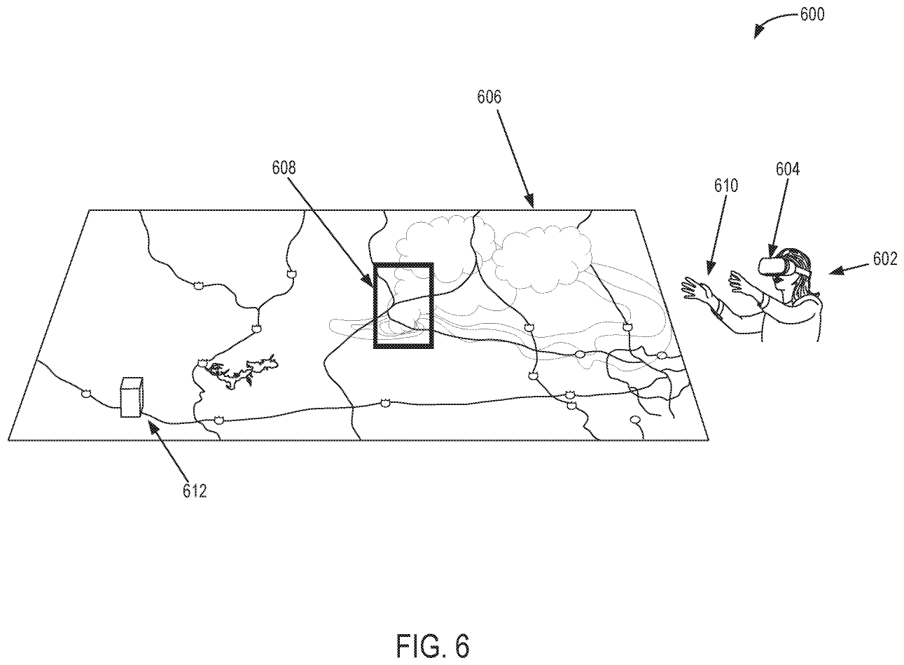

FIG. 6 illustrates a system for AR-DWR visualization 600 in accordance with some embodiments. Illustrated in FIG. 6 is user 602, headset 604, 3D weather display 606, weather alert selection 608, hand gestures 610, and cube 612. The user 602 may be viewing the 3D weather display 606 using the headset 604, and the user 602 may select weather alert selection 608 (e.g., tornado or wind conditions for tornado watch) using hand gestures. The user 602 may be the same or similar as user 146. The headset 604 may be the same or similar as headset 128. The 3D weather display 606 may be the same or similar as 3D weather display 134. The weather alert selection 608 may be a weather alert 142 that is defined by hand gestures 610 that are recognized by hand recognition 136. In some embodiments, the weather alert selection 608 may initiate a sequence where a weather alert 142 is created and sent to a central weather site for transmission to other 4D AR-DWR visualizations. The cube 612 may be the same or similar as cube 138. The cube 612 may be manipulated into different positions by the user 602 to retrieve weather data (not illustrated) inside the cube, e.g., there may be displayed exact wind velocity data for the area inside the cube 612. The AR-DWR visualization may be 4D in that it may be animated in real-time. The AR-DWR visualization may enable the user 602 to better identify the weather alert of the weather alert selection 608 by displaying a large amount of 3D weather data in real time.

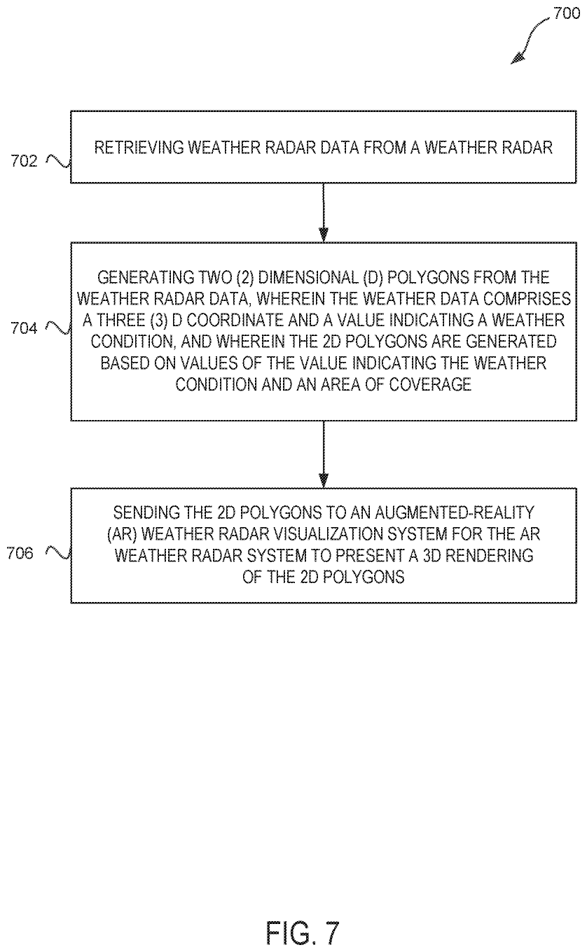

FIG. 7 illustrates a method for AR-DWR visualization 700 in accordance with some embodiments. The method 700 begins at operation 702 with retrieving weather radar data from a weather radar. For example, AR-DWR module 112 may retrieve raw data 108 from database 106. In another example, RDA 104 or another entity may send the raw data 108 to AR-DWR module 112.

The method continues at operation 704 with generating 2D polygons from the weather radar data, where the weather data comprises a 3D coordinate and a value indicating a weather condition, and where the 2D polygons are generated based on values of the value indicating the weather condition and an area of coverage. For example, data processing module 114 may generate 2D objects 118 with a same data type 120 having values. The generation of the 2D objects 118 may be based on an area of coverage (not illustrated) and based on the values of the data types 120 being equal or similar.

The method continues at operation 706 with sending the 2D polygons to an AR weather radar visualization system for the AR weather radar system to present a 3D rendering of the 2D polygons. For example, AR-DWR module 112 may send the 2D objects 118 to the AR-DWR hardware 126 for 4D AR-DWR visualization 132.

One or more operations of method 700 may be optional. One or more additional operations may be part of method 700. In some embodiments, the order of the operations of method 700 may be different.

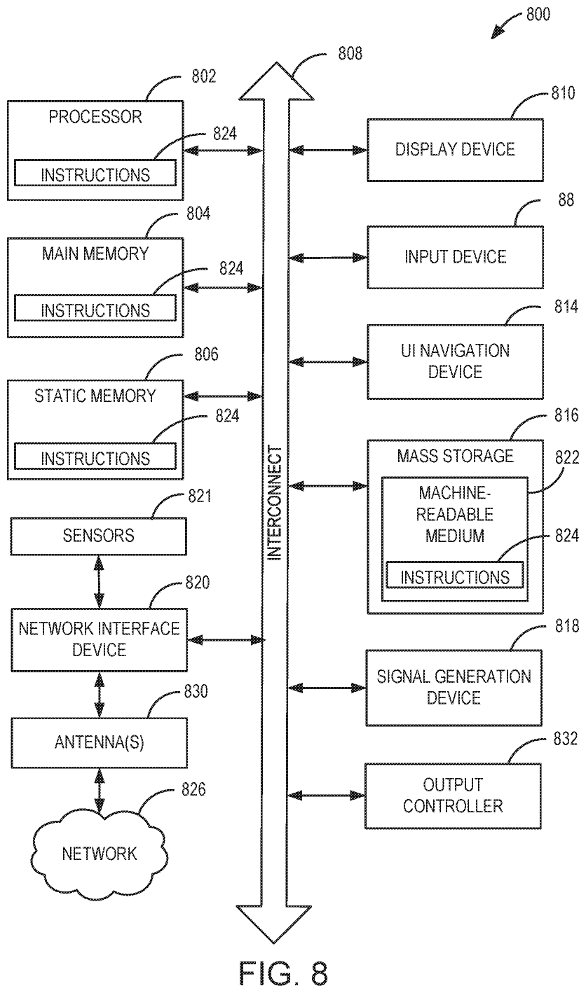

FIG. 8 illustrates a block diagram of an example machine 800 upon which any one or more of the techniques (e.g., methodologies) discussed herein may perform. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be a server, personal computer (PC), a tablet PC, a set-top box (STB), a personal digital assistant (PDA), a portable communications device, AR hardware, a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808.

Specific examples of main memory 804 include Random Access Memory (RAM), and semiconductor memory devices, which may include, in some embodiments, storage locations in semiconductors such as registers. Specific examples of static memory 806 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 800 may further include a display device 810, an input device 812 (e.g., a keyboard), and a user interface (UI) navigation device 814 (e.g., a mouse). In an example, the display device 810, input device 812 and UI navigation device 814 may be a touch screen display. In an example, the display device 810 may be an AR headset and navigation device 814 may be a handheld interface pen. The machine 800 may additionally include a mass storage (e.g., drive unit) 816, a signal generation device 818 (e.g., a speaker), a network interface device 820, and one or more sensors 821, such as a global positioning system (GPS) sensor, compass, accelerometer, video camera, or other sensor. The machine 800 may include an output controller 832, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments the processor 802 and/or instructions 824 may comprise processing circuitry and/or transceiver circuitry.

The storage device 816 may include a machine readable medium 822 on which is stored one or more sets of data structures or instructions 824 (e.g., software) embodying or utilized by any one or more of the techniques or functions described herein. For example, one or more of AR-DWR module 112, RDA 104, processing engine 162, interaction module 116, data processing module 114 may be implemented by machine 800 to form a special purpose machine 800. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine-readable media. Example machine-readable medium may include non-transitory machine-readable medium that may include tangible non-transitory medium for storing information in a form readable by one or more computers, such as but not limited to read only memory (ROM); random access memory (RAM); magnetic disk storage media; optical storage media; a flash memory, etc.

Specific examples of machine readable media may include: non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine readable medium 822 is illustrated as a single medium, the term “machine readable medium” may include a single medium or multiple media (e.g., a centralized or distributed database, and/or associated caches and servers) configured to store the one or more instructions 824.

The instructions 824 may further be transmitted or received over a communications network 826 using a transmission medium via the network interface device 820 utilizing any one of a number of transfer protocols (e.g., frame relay, internee protocol (P), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, Licensed Assisted Access (LAA), IEEE 802.15.4 family of standards, a Long Term Evolution (LIE) family of standards, a Universal Mobile Telecommunications System (UMTS) family of standards, peer-to-peer (P2P) networks, among others.

In an example, the network interface device 820 may include one or more physical jacks (e.g., Ethernet, coaxial, or phone jacks) or one or more antennas to connect to the communications network 826. In an example, the network interface device 820 may include one or more antennas 830 to wirelessly communicate using at least one of single-input multiple-output (SIMO), multiple-input multiple-output (MIMO), or multiple-input single-output (MISO) techniques. In some examples, the network interface device 820 may wirelessly communicate using Multiple User MIMO techniques. The term “transmission medium” shall be taken to include any intangible medium that is capable of storing, encoding or carrying instructions for execution by the machine 800, and includes digital or analog communications signals or other intangible medium to facilitate communication of such software.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

What is claimed is:

1. A computer-implemented method, the method comprising:
retrieving weather radar data from a weather radar;
generating two (2) dimensional (D) polygons from the weather radar data, wherein the weather data comprises a three (3) D coordinate and a value indicating a weather condition, and wherein the 2D polygons are generated based on values of the value indicating the weather condition and an area of coverage; and
sending the 2D polygons to an augmented-reality (AR) weather radar visualization system for the AR weather radar system to present a 3D rendering of the 2D polygons.

2. The computer-implemented method of claim 1, wherein the weather radar data is for a previous time, and wherein the computer-implemented method further comprises:
retrieving additional weather radar data from the weather radar, wherein the additional radar data is for a current time;
generating additional 2D polygons from the additional weather radar data; and
sending the additional 2D polygons to the AR weather radar visualization system for the AR weather radar system to present additional 3D rendering of the additional 2D polygons, wherein the 2D polygons are generated a real-time threshold before the current time.

3. The computer-implemented method of claim 2, wherein the real-time threshold before the current time is between 0.01 second and 5 seconds.

4. The computer-implemented method of claim 1, wherein the computer-implemented method further comprises:
determining a weather alert from the weather radar data, wherein the weather alert indicates an alert area of the coverage area; and
sending the weather alert to the AR visualization system for the AR visualization system to present the weather alert.

5. The computer-implemented method of claim 4, wherein determining the weather alert further comprises:
determining the weather alert by comparing the weather radar data with predetermined models of weather alerts, wherein the weather alerts comprise strong winds, shearing winds, a tornado, and hail.

6. The computer-implemented method of claim 1, wherein the computer-implemented method further comprises:
receiving from an application across a computer network, a weather alert based on the weather radar data, the weather alert indicating an alert area; and
in response to the coverage area including the alert area, sending the weather alert to the AR visualization system for the AR visualization system to present the weather alert.

7. The computer-implemented method of claim 1, wherein the computer-implemented method further comprises:
receiving a request from the AR weather radar visualization system for additional 2D polygons for a different area of coverage;
generating the additional 2D polygons from the weather radar data for the different area of coverage; and
sending the 2D polygons to the AR weather radar visualization system for the system to present a different 3D rendering of the additional 2D polygons.

8. The computer-implemented method of claim 1, wherein the weather radar data is x-band radar data with a range of 18 nano-meters or less.

9. The computer-implemented method of claim 7, wherein a type of the weather radar data is one of the following group: a velocity, a reflectivity, a radial velocity, and a spectrum width.

10. The computer-implemented method of claim 1, wherein the computer-implemented method further comprises:
receiving an indication of a weather alert from the AR weather radar visualization system, wherein the weather alert indicates an alert area of the coverage area; and
sending the weather alert across a computer network to a central weather service.

11. The computer-implemented method of claim 1, wherein the computer-implemented method further comprises:
receiving a request from the AR weather radar visualization system for weather radar data within an area of a cube, wherein the area of the cube is within the area of coverage;
determining the weather radar data within the area of the cube; and
sending the weather radar data within the area of the cube to the AR weather radar visualization system for the system to present the weather radar data within the area of the cube.

12. The computer-implemented method, wherein the weather radar data is for a threshold of time, and wherein sending the 2D polygons further comprises:
sending the 2D polygons to the AR weather radar visualization system for the AR weather radar system to present a 3D rendering of the 2D polygons before the end of the threshold of time.

13. The computer-implemented method of claim 12, wherein the threshold of time is between 0.01 of a second and 1 second.

14. A computing device, the computing device comprising:
a processor;
a memory, comprising instructions, which when performed by the processor, cause the processor to perform operations comprising:
retrieving weather radar data from a weather radar;
generating two (2) dimensional (D) polygons from the weather radar data, wherein the weather data comprises a three (3) D coordinate and a value indicating a weather condition, and wherein the 2D polygons are generated based on values of the value indicating the weather condition and an area of coverage; and
sending the 2D polygons to an augmented-reality (AR) weather radar visualization system for the AR weather radar system to present a 3D rendering of the 2D polygons.

15. The computing device of claim 14, wherein the weather radar data is for a previous time, and wherein the instructions further cause the processor to perform operations comprising:
retrieving additional weather radar data from the weather radar, wherein the additional radar data is for a current time;
generating additional 2D polygons from the additional weather radar data; and
sending the additional 2D polygons to the AR weather radar visualization system for the AR weather radar system to present additional 3D rendering of the additional 2D polygons, wherein the 2D polygons are generated a real-time threshold before the current time.

16. The computing device of claim 15, wherein the real-time threshold before the current time is between 0.01 second and 5 seconds.

17. The computing device of claim 14, wherein the instructions further cause the processor to perform operations comprising:
determining a weather alert from the weather radar data, wherein the weather alert indicates an alert area of the coverage area; and
sending the weather alert to the AR visualization system for the AR visualization system to present the weather alert.

18. A non-transitory computer-readable storage medium that stores instructions for execution by one or more processors, the operations to configure the one or more processors to:
retrieve weather radar data from a weather radar;
generate two (2) dimensional (D) polygons from the weather radar data, wherein the weather data comprises a three (3) D coordinate and a value indicating a weather condition, and wherein the 2D polygons are generated based on values of the value indicating the weather condition and an area of coverage; and
send the 2D polygons to an augmented-reality (AR) weather radar visualization system for the AR weather radar system to present a 3D rendering of the 2D polygons.

19. The non-transitory computer-readable storage medium of claim 18, wherein the operations further configure the one or more processors to:
retrieve additional weather radar data from the weather radar, wherein the additional radar data is for a current time;
generate additional 2D polygons from the additional weather radar data; and
send the additional 2D polygons to the AR weather radar visualization system for the AR weather radar system to present additional 3D rendering of the additional 2D polygons, wherein the 2D polygons are generated a real-time threshold before the current time.

20. The non-transitory computer-readable storage medium of claim 18, wherein the operations further configure the one or more processors to:
determining a weather alert from the weather radar data, wherein the weather alert indicates an alert area of the coverage area; and
sending the weather alert to the AR visualization system for the AR visualization system to present the weather alert.
